(19) United States
(12) Patent Application Publication
(10) Pub. No.: US 2017/0336881 A1
(43) Pub. Date: Nov. 23, 2017

(54) DISCRETE CURSOR MOVEMENT BASED ON TOUCH INPUT REGION

(71) Applicant: HEWLETT-PACKARD DEVELOPMENT COMPANY, L.P., HOUSTON, TX (US)

(72) Inventors: KAS KASRAVI, BLOOMINGTON, MI (US); OLEG VASSILIEVICH NIKOLSKY, PONTIAC, MI (US)

(21) Appl. No.: 15/535,840

(22) PCT Filed: Jan. 5, 2015
(86) PCT No.: PCT/US2015/010087

§ 371 Date: Jun. 14, 2017

(51) Int. Cl. G06F 3/0346; G06F 3/041

(52) U.S. Cl. CPC G06F 3/0346; G06F 3/0418; G06F 2200/1636

(57) ABSTRACT

In one example implementation according to aspects of the present disclosure, a touch input is received on a touch input region of a computing system, the touch input region being one of a plurality of touch input regions. Responsive to the received touch input, a linear touch input signal and a rotational touch input signal are generated. A discrete cursor movement from a set of discrete cursor movements is then determined and caused to be implemented based at least in part on an analysis of the linear signal and on an analysis of the rotational signal.

### BACKGROUND

Computing devices such as laptops, smart phones, wearable computing devices, and tablets have increased in popularity. Many individuals own at least one (if not multiple) of these types devices, which may frequently be used for personal tasks such as checking email, browsing the Internet, taking photos, playing games, and other such activities. Additionally, these devices are also being used to perform basic business related tasks, such as email, accessing business web services, and internet browsing.

### BRIEF DESCRIPTION OF THE DRAWINGS

The following detailed description references the drawings, in which:

FIG. 1 illustrates a block diagram of a computing system 100 to generate discrete cursor movement based on a touch input region according to examples of the present disclosure;

FIG. 2 illustrates a block diagram of a computing system 200 to generate discrete cursor movement based on a touch input region according to examples of the present disclosure;

FIG. 3 illustrates a flow diagram of a method 300 to determine discrete cursor movement based on touch input region according to examples of the present disclosure;

FIG. 4 illustrates a flow diagram of a method 400 to determine discrete cursor movement based on touch input region according to examples of the present disclosure;

FIG. 5 illustrates a block diagram of a computing system 400 to generate discrete cursor movement based on a plurality of touch input regions according to examples of the present disclosure; and

FIGS. 6A-6G illustrate signals generated by at least one of a plurality of accelerometers and/or a gyroscope representative of touch inputs received on regions of a computing device as illustrated in FIG. 4 according to examples of the present disclosure.

### DETAILED DESCRIPTION

Computing devices (or computing systems) such as laptops, smart phones, and tablets have increased in popularity. Many individuals own at least one (if not multiple) of these types devices, which may frequently be used for personal tasks such as checking email, browsing the Internet, taking photos, playing games, and other such activities. Additionally, these devices are also being used to perform basic business related tasks, such as email, accessing business web services, and internet browsing.

To perform the desired tasks and functions, users interact with these computing systems by providing a variety of inputs. For example, a user may enter text on a physical keyboard attached to such a computing system. Similarly, the user may enter text on a “soft” keyboard that appears on a touch display of such a computing system. For instance, a user of a mobile smart phone may wish to compose an email or a text message. To do so, the user may select the appropriate application (e.g., email application or text messaging application) by clicking or tapping on the mobile smart phone's touch screen. Once the appropriate application is running, the user may then proceed to input the desired text using the soft keyboard displayed on the touch screen by selecting or tapping the appropriate characters. Users may perform other tasks on their computing systems that utilize user inputs such as office productivity software, gaming software, image editing software, computer aided design software, and the like.

To provide such inputs, the users of such devices face the limitations of touch screen implementations. For instance, a user may frequently mistype a word because the on-screen keyboard is small in comparison to the user's fingers. That is, a user may mean to press one key and instead press an adjacent key. To correct this error, the user moves the cursor back to the position of the mistake and makes the appropriate correction. However, moving the cursor to a particular location can be difficult on such touch screen devices. More generally, touch screen devices lack precise and discrete input ability, specifically as it relates to the position and movement of a cursor. This shortcoming limits and negatively affects the manner in which applications are implemented and used, limits the usefulness of the computing system, and causes user frustration.

In some implementations, techniques for providing user input to a computing system include touchscreens, mice, styluses, mechanical buttons, software buttons, and voice commands. These current techniques fail to provide precise cursor control on touchscreen devices. For example, touchscreens are inherently inaccurate, mice and styluses need to be carried as an extra device, software or screen buttons take up space and add to the cost of the computing system, and voice command are not intended for, nor do they provide, precision cursor control.

Various implementations are described below by referring to several examples of discrete cursor movement based on touch input regions of a computing device. In one example implementation according to aspects of the present disclosure, a touch input is received on a touch input region of a computing system, the touch input region being one of a plurality of touch input regions. Responsive to the received touch input, a linear touch input signal and a rotational touch input signal are generated. The linear touch input signal is generated by an accelerometer and is representative of a linear movement of the computing device caused by the touch input. The rotational input signal is generated by a gyroscope and is representative of a rotational movement of the computing device caused by the touch input. A discrete cursor movement from a set of discrete cursor movements is then determined and caused to be implemented based at least in part on an analysis of the linear signal generated by the accelerometer and based at least in part on an analysis of the rotational signal generated by the gyroscope. Additional examples are described herein.

In some implementations, the discrete cursor movement techniques described herein save the user frustration when discrete or high precision cursor movement is needed. Moreover, applications may provide increased functionality as a result of the ability to provide discrete cursor movements without the added cost of additional hardware components. These and other advantages will be apparent from the description that follows.

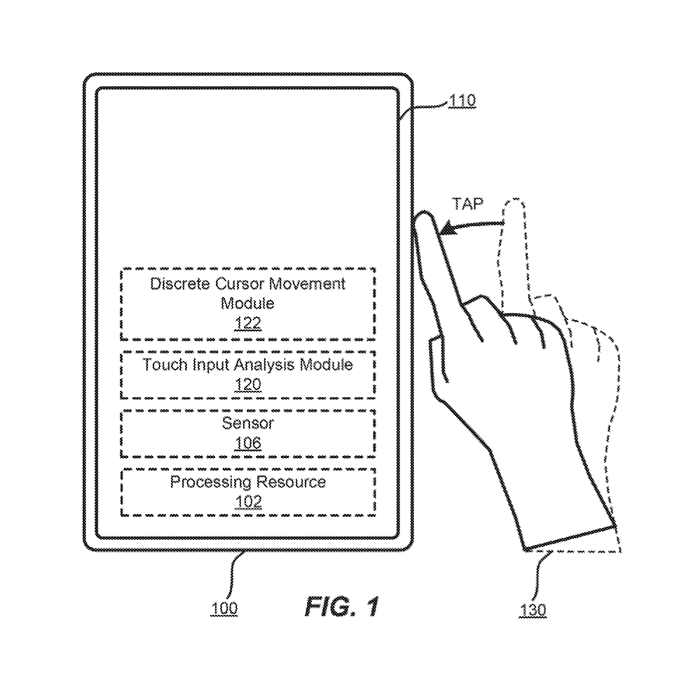

FIGS. 1-3 include particular components, modules, instructions etc. according to various examples as described herein. In different implementations, more, fewer, and/or other components, modules, instructions, arrangements of components/modules/instructions, etc. may be used according to the teachings described herein. In addition, various components, modules, etc. described herein may be implemented as instructions stored on a computer-readable storage medium, hardware modules, special-purpose hardware (e.g., application specific hardware, application specific integrated circuits (ASICs), embedded controllers, hardwired circuitry, etc.), or some combination or combinations of these.

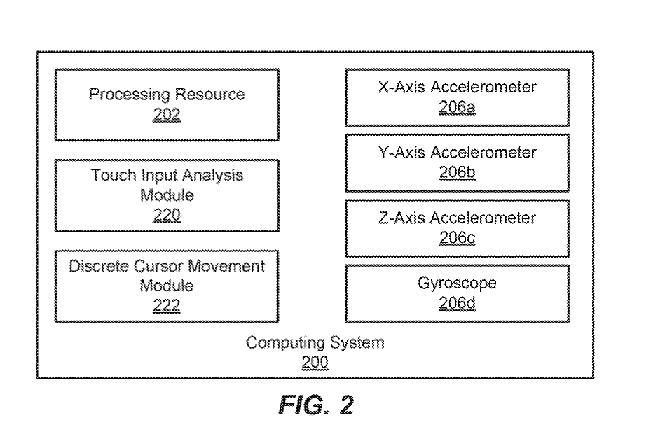

Generally, FIGS. 1-3 relate to components and modules of a computing system, such as computing system 100 of FIG. 1 and computing system 200 of FIG. 2. It should be understood that the computing systems 100 and 200 may include any appropriate type of computing system and/or computing device, including for example smartphones, tablets, desktops, laptops, workstations, servers, smart monitors, smart televisions, digital signage, scientific instruments, retail point of sale devices, video walls, imaging devices, peripherals, networking equipment, or the like.

The present disclosure enhances a user experience by providing more options for discrete and precise touch input against a computing system such as a mobile computing device. In examples, various surfaces of a mobile device are divided into regions, (e.g., corners, upper right side, lower left edge, etc.). The user's touch inputs (e.g., finger taps) on these regions are detected by the device's accelerometer and/or gyroscope outputs. A de-noising technique, such as discrete wavelet transform, is applied to analyze detected touch input signals generated by the accelerometer and/or gyroscope. The accelerometers and/or gyroscope report changes both in position (linear) and orientation (rotational). These touch inputs against specific regions are identified and classified via the analysis. In further examples, a database maps various regions to various desired discrete cursor movements. Using heuristics, the combination of the taps on various regions are identified and mapped to the action desired by the user.

FIG. 1 illustrates a block diagram of a computing system 100 to generate discrete cursor movement based on a touch input region according to examples of the present disclosure. In particular, the computing system 100 may detect a series of touch inputs (or “taps”) from a user hand 130 (or in another appropriate way such as by a user finger, head, arm, etc.) via a sensor 106, analyze signals generated by the sensor 106 corresponding to the training touch inputs, and generate a discrete cursor movement based on the analysis of the signals corresponding to the touch input. Thus, when a user taps the computing system 100, a discrete cursor movement may be implemented on the device based on the touch input. The discrete cursor movement causes the cursor to move a discrete amount (or to a particular location), move to a discrete menu item or button, or to discretely select an object, menu item, or button, or another similar action is performed.

FIG. 1 includes particular components, modules, etc. according to various examples. However, in different implementations, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

It should be understood that the computing system 100 may include any appropriate type of computing device, including for example smartphones, tablets, desktops, laptops, workstations, servers, smart monitors, smart televisions, digital signage, scientific instruments, retail point of sale devices, video walls, imaging devices, peripherals, wearable computing devices, or the like.

In the example illustrated in FIG. 1, the computing system 100 represents a mobile device, such as a smart phone or tablet computer, although other suitable devices are also possible. The computing system 100 includes a processing resource 102, a sensor 106, a touch input analysis module 120, a discrete cursor movement module 122, and a display 110. The sensor 106, the touch input analysis module 120, and the discrete cursor movement module 122 are shown with dashed lines to represent that the components are partially or wholly within the computing system 100 and may not be visible externally to the computing system 100. In other examples, the computing system 100 may include additional components, such as processing resources, memory resources, additional sensors, and the like. In examples, the sensor 106 may represent a variety of different sensors, including accelerometers, gyroscopes, magnetometer, manometer, and the like. In examples, the sensor 106 may be an accelerometer to generate a linear signal responsive to detecting a linear movement with respect to at least one of an x-axis, a y-axis, and a z-axis, the linear movement being caused by a touch input received on a region of the computing system.

In some examples of the present disclosure, accelerometers output a signal representative of the difference between the linear acceleration in the device's reference frame and the Earth's gravitational field vector. If linear acceleration is absent, the accelerometer outputs a measure of orientation/rotation of the device, which can be mapped to pitch (about X axis), roll (about Y axis), and yaw (about Z axis).

The touch input analysis module 120 of the computing system 100 analyzes signals generated by a sensor 106. The signals correspond to a touch input (or inputs) detected by the sensor 106. For example, hand 130 may “tap” or similarly touch a surface of the computing system 100 so as to create a touch input. The touch input is registered by the sensor 106, which generates a signal or signals responsive to the touch input being detected.

Once the touch input (or “tap”) is detected by the computing system 100 and the signal is generated by the sensor 106, the touch input analysis module 120 analyzes the signal generated by the sensor 106. In examples, a series of touch inputs may be received on the computing system 100 and recognized by the sensor 106. The sensor 106 may then generate a plurality of signals corresponding to each of the touch inputs. The plurality of signals are then analyzed by the touch input analysis module 120. The touch input analysis module 122, for example, analyzes a linear signal generated by the accelerometer by applying a signal de-noising algorithm to the linear signal generated by the accelerometer.

In examples, the touch input analysis module 120 may apply a discrete wavelet transform procedure to de-noise the signals generated by the sensor 106. Any noise present in the signal generated by the sensor 106 is reduced and/or removed by the de-noising procedures. Consequently, the de-noising procedure may remove the noise from the signal. In other examples, the de-noising procedure may apply other de-noising procedures other than the discrete wavelet transform procedure, such as by using other types of appropriate wavelet transforms, digital signal processing for time-frequency analysis, or any other suitable transform procedure such as Kalman filters, recursive least square filters, Bayesian mean square error procedure, etc. Moreover, in some examples, a custom data filtering procedure may be implemented.

Additionally, the touch input analysis module 120 analyzes which surface and/or region of the computing system 100 received the touch. For example, although FIG. 1 illustrates the hand 130 touching the left surface of the computing system 100, any of the left, right, top, and/or bottom surfaces may be similarly tapped or touched. Additionally, the front surface (such as the display 110) and/or the rear surface (not shown) may be similarly tapped or touched in examples.

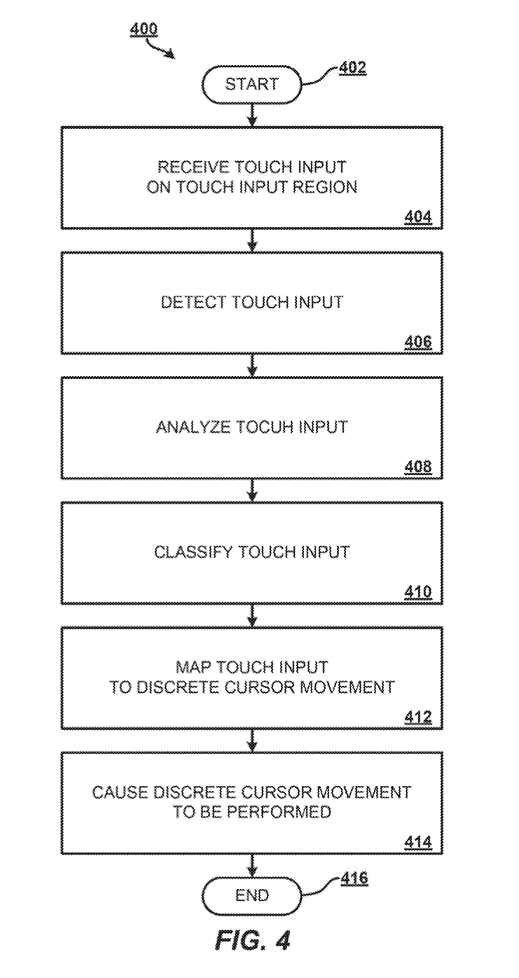

In additional examples, such as shown in FIG. 4, additional regions may be utilized. For example, corners of the computing system 100 may be separate regions from the edge surfaces, as is discussed below.

After the signal generated by the sensor 106 has been analyzed by the touch input analysis module 120, the discrete cursor movement module 122 determines which of a discrete cursor movement from a set of discrete cursor movements to cause to be implemented based at least in part on the analysis of the signal generated by the sensor. For example, the discrete cursor movement module 122 determines which of a discrete cursor movement from a set of discrete cursor movements to cause to be implemented based at least in part on the analysis of the linear signal generated by the accelerometer.

FIG. 2 illustrates a block diagram of a computing system 200 to generate discrete cursor movement based on a touch input region according to examples of the present disclosure. In particular, the computing system 200 includes a plurality of accelerometers 206a-202c, a gyroscope 206d, a touch input analysis module 220, and a discrete cursor movement module 222.

The plurality of accelerometers may include three separate accelerometers or a single accelerometer configured to detect motion along three axes. In examples, the plurality of accelerometers includes a first accelerometer to generate an x-axis linear signal responsive to detecting a linear movement along an x-axis being caused by a touch input received on a touch input region of the computing system, a second accelerometer to generate a y-axis linear signal responsive to detecting a linear movement along a y-axis being caused by the touch input on the computing system, and a third accelerometer to generate a z-axis linear signal responsive to detecting a linear movement along a z-axis being caused by the touch input on the computing system.

The computing system 200 may also include a gyroscope 206d to generate a rotational signal responsive to detecting a rotational movement caused by the touch input on the computing system. In examples, the rotational input signal is at least one of a pitch touch input signal representative of a movement of the computing device about an x-axis, a roll touch input signal representative of a movement of the computing device about a y-axis, and yaw touch input signal representative of a movement of the computing device about a z-axis.

The computing system 200 further includes a touch analysis module 220 to analyze at least one of the linear signals generated by the plurality of accelerometers and to analyze the rotational signal generated by the gyroscope. The touch analysis module analyzes the linear signals and the rotational signal by applying a signal de-noising algorithm to the signal generated by the accelerometer. In examples, the signal de-noising algorithm is a discrete wavelet transform algorithm or other appropriate type of transform, such as those described herein.

To combine the multi-axis information (e.g., x-axis, y-axis, and z-axis), both from the linear and rotational movements on and about the axes, several possible techniques may be utilized. For example, a measure of signal strength, such as large versus small, may be used. If, in that example, a signal is above 50%, it may be considered large, while a signal below 50% may be considered small. The large signals may indicate that a touch input occurred, while the small signals may indicate that no touch input occurred.

Another technique may use ranges of numbers (e.g., 20%, 30%, 50%, 70%, etc.). In this example, measuring the accelerometer output may result in a signal strength, the higher of which may indicate that a touch input occurred while lower values may indicate that no touch input occurred.

An additional technique may apply “fuzzy logic” techniques that look at the partial memberships into different sets. For example, if a hard touch input occurs on the upper side region, and 80% change of hitting the upper right corner may exist, while only a 20% change of hitting he upper side corner exists. In this case, the touch input would be treated as having hit the upper right corner.

These techniques may be further implemented using machine leaming and heuristics, such that these techniques may be adapted and customized, either by a user of the device or automatically by the device itself as it leams and adapts to the user's behavior.

The computing system 200 also includes a discrete cursor movement module to determine which of a discrete cursor movement from a set of discrete cursor movements to cause to be implemented based at least in part on the analysis of the linear signals generated by the plurality of accelerometers and based at least in part on the analysis of the rotational signal generated by the gyroscope. In examples, the rotational signal is at least one of a pitch touch signal representative of a movement of the computing device about an x-axis, a roll touch signal representative of a movement of the computing device about a y-axis, and yaw input signal representative of a movement of the computing device about a z-axis.

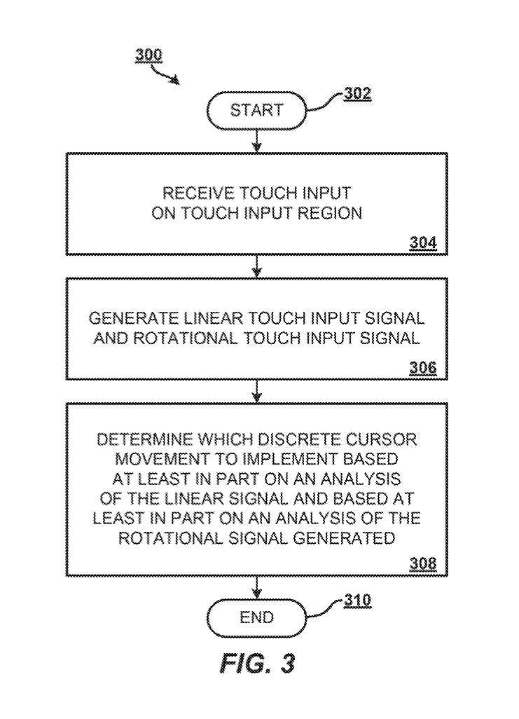

FIG. 3 illustrates a flow diagram of a method 300 to determine discrete cursor movement based on touch input region according to examples of the present disclosure. The method 300 may be executed by a computing system or a computing device such as computing system 100 of FIG. 1 and/or computing system 200 of FIG. 2. The method 300 may also be stored as instructions on a non-transitory computer-readable storage medium that, when executed by a processor (e.g., processing resource 102 of FIG. 1), cause the processor to perform the method 300.

At block 302, the method 300 begins and continues to block 304. At block 304, the method 300 includes a computing system (e.g., computing system 100 of FIG. 1) receiving a touch input on a touch input region of the computing system, the touch input region being one of a plurality of touch input regions. The method 300 continues to block 306.

At block 306, the method 300 includes the computing system generating, responsive to the received touch input, a linear touch input signal and a rotational touch input signal. In examples, the linear touch input signal is generated by an accelerometer and is representative of a linear movement of the computing device caused by the touch input. The linear touch input signal may be, in examples, at least one of an x-axis touch input signal representative of a movement of the computing device along an x-axis, a y-axis touch input signal representative of a movement of the computing device along a y-axis, and a z-axis touch input signal representative of a movement of the computing device along a z-axis. In additional examples, the rotational touch input signal is generated by a gyroscope and is representative of a rotational movement of the computing device caused by the touch input. The rotational input signal may be, in examples, at least one of a pitch touch input signal representative of a movement of the computing device about an x-axis, a roll touch input signal representative of a movement of the computing device about a y-axis, and yaw touch input signal representative of a movement of the computing device about a z-axis. The method 300 continues to block 308.

At block 308, the method 300 includes the computing system determining which of a discrete cursor movement from a set of discrete cursor movements to cause to be implemented based at least in part on an analysis of the linear signal generated by the accelerometer and based at least in part on an analysis of the rotational signal generated by the gyroscope. The method 300 then continues to block 310 and terminates.

Additional processes also may be included, and it should be understood that the processes depicted in FIG. 3 represent illustrations, and that other processes may be added or existing processes may be removed, modified, or rearranged without departing from the scope and spirit of the present disclosure.

FIG. 4 illustrates a flow diagram of a method 400 to determine discrete cursor movement based on touch input region according to examples of the present disclosure. The method 400 may be executed by a computing system or a computing device such as computing system 100 of FIG. 1 and/or computing system 200 of FIG. 2. The method 400 may also be stored as instructions on a non-transitory computer-readable storage medium that, when executed by a processor (e.g., processing resource 102 of FIG. 1), cause the processor to perform the method 400.

At block 402, the method 400 begins and continues to block 404. At block 404, the method 400 includes a computing system (e.g., computing system 100 of FIG. 1) receiving a touch input on a touch input region of the computing system. The method 400 continues to block 406. At block 406, the method 400 includes the computing system detecting the touch input, for example, using a sensor such as a gyroscope and/or accelerometer. The method 400 continues to block 408. At block 408, the method 400 includes the computing system analyzing the touch input. The method 400 continues to block 410. At block 410, the method 400 includes the computing system classifying the touch input, which may include classifying which region of the computing system received the touch input. The method 400 continues to block 412. At block 412, the method 400 includes the computing system mapping the touch input to a discrete cursor movement, such as using heuristics or other rules stored in a discrete cursor movement data store. The method 400 then continues to block 414. At block 414, the method 400 includes causing the discrete cursor movement to be performed on the computing device. The method 400 continues to block 416 and terminates.

Additional processes also may be included, and it should be understood that the processes depicted in FIG. 4 represent illustrations, and that other processes may be added or existing processes may be removed, modified, or rearranged without departing from the scope and spirit of the present disclosure.

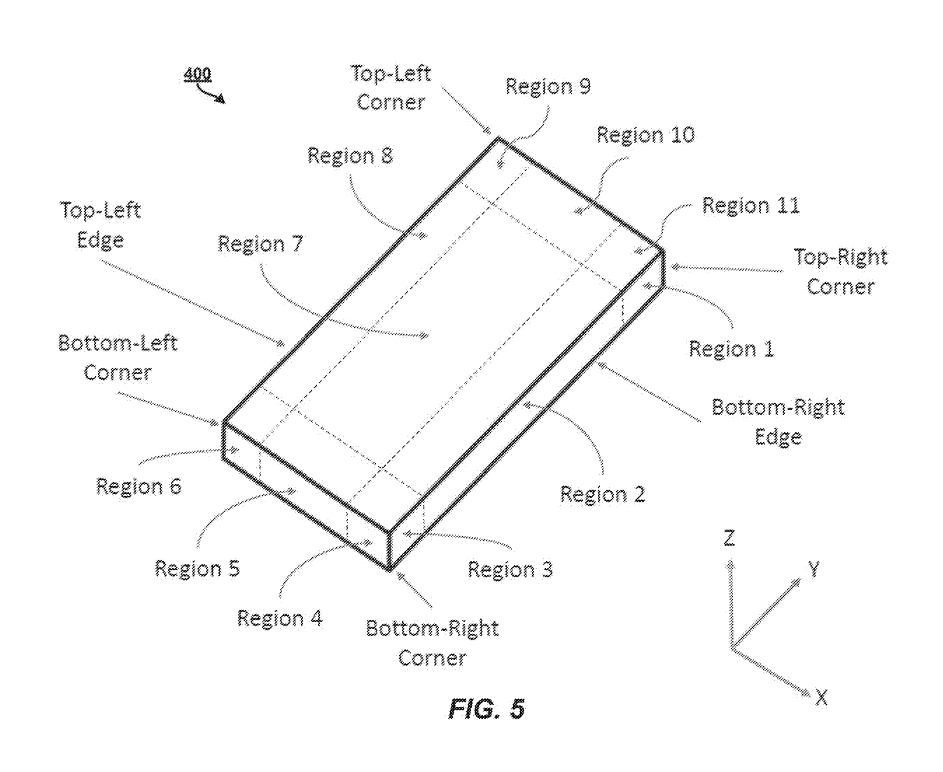

FIG. 5 illustrates a block diagram of a computing system 400 to generate discrete cursor movement based on a plurality of touch input regions according to examples of the present disclosure. The example of FIG. 5 illustrates the following regions: regions 1-11, top-right corner, bottom-right edge, bottom-right corner, top-left corner, top-left edge, and top-left corner.

In particular, FIG. 5 illustrates an example of how the surface area of a mobile computing device may be divided into a plurality of regions, including edges and corners. Tapping each of these regions may produce a distinct and detectable set of signals (both linear and rotational) from the sensors (e.g., accelerometer(s), gyroscope(s), etc.) within the mobile computing device. In this example, there are a total of 30 regions, 8 edges, and 4 corners (i.e., 42 touch input regions). However, it should be understood that more or fewer regions may be useful in other examples. Moreover, the size, shape, and/or orientation of the regions may be altered, for example, by a user of the computing system 500 and/or automatically based on heuristics and learned characteristics of the touch inputs. Moreover, the size, shape, and/or orientation may depend on the type of analysis applied to the sensor signals and/or on the accuracy of the sensors used in the computing system 500. Although not each of the 42 regions are labeled, the non-labeled regions should be understood.

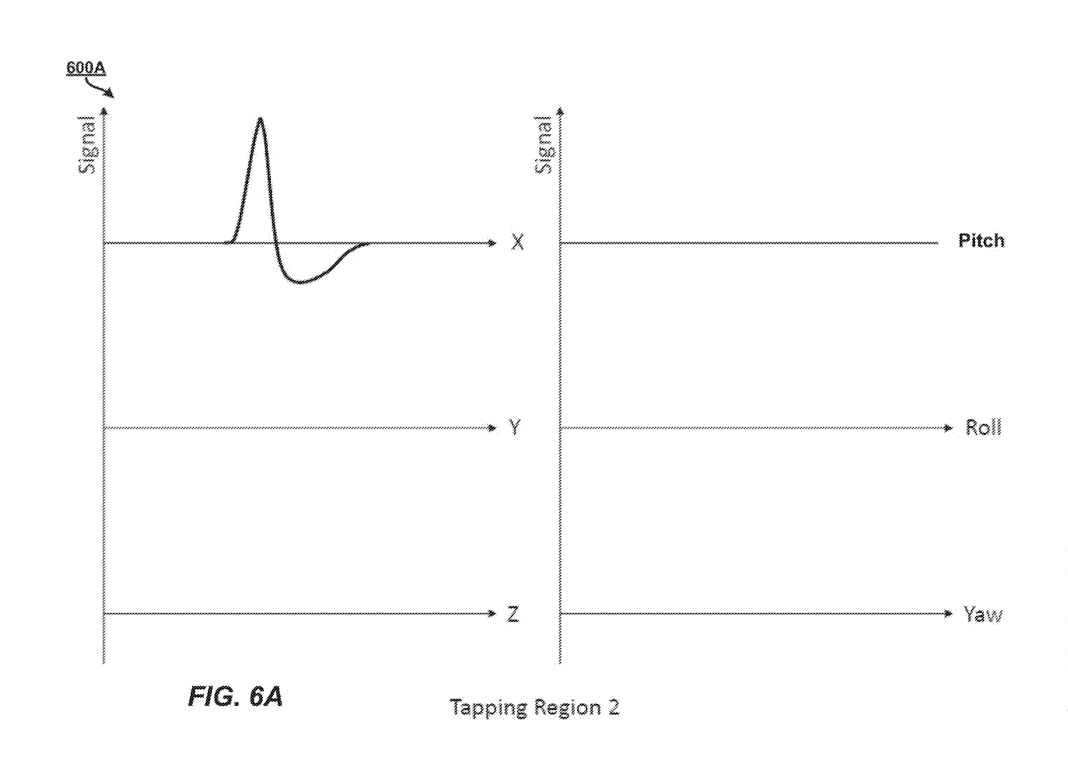

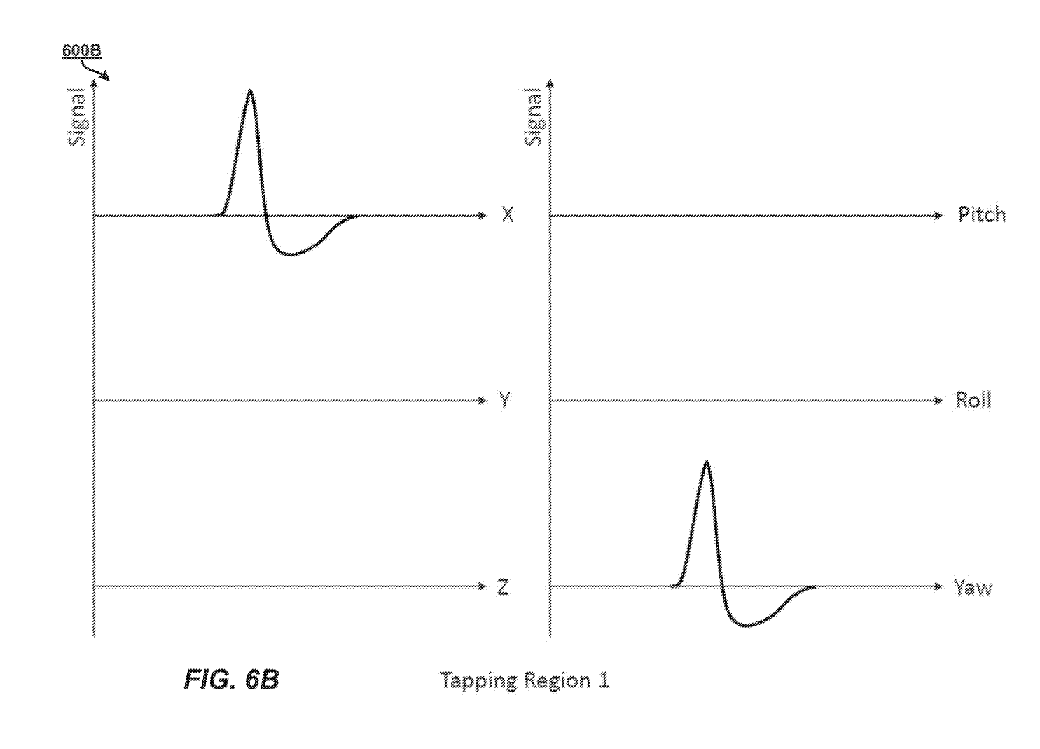

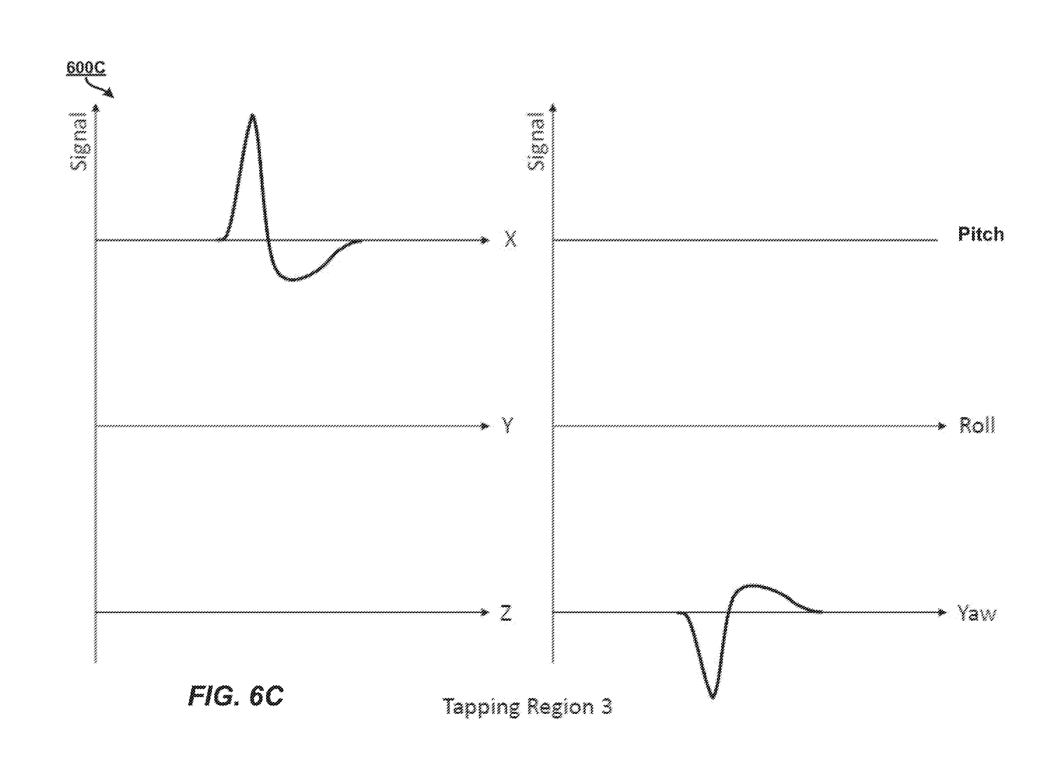

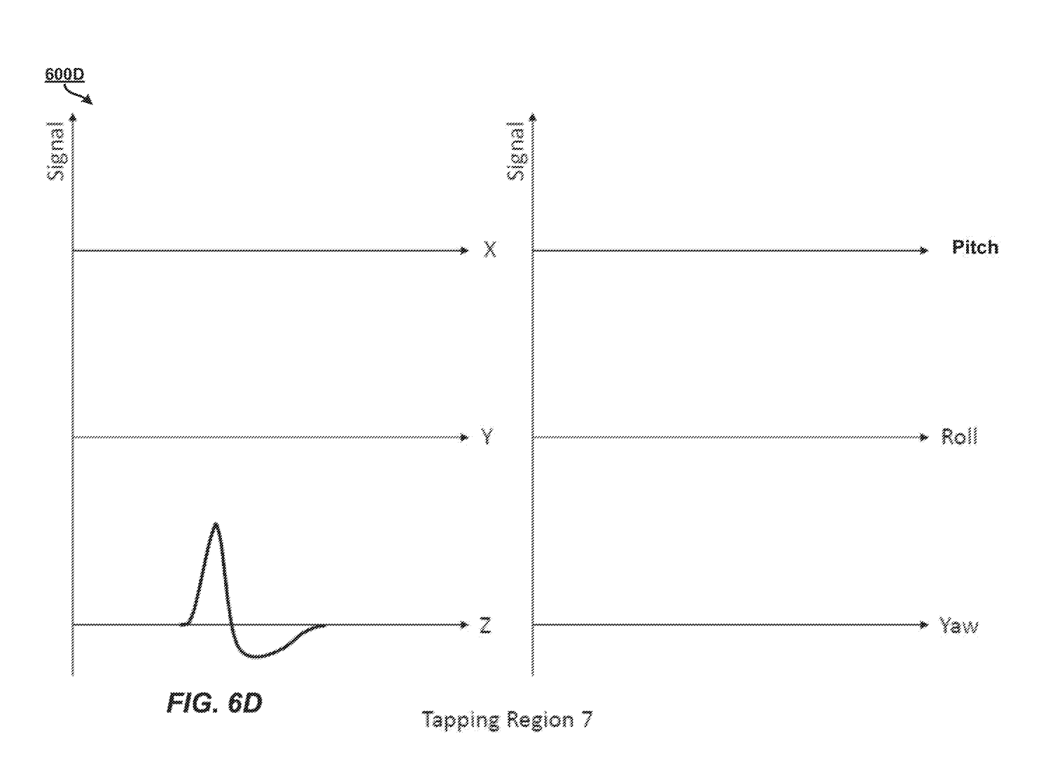

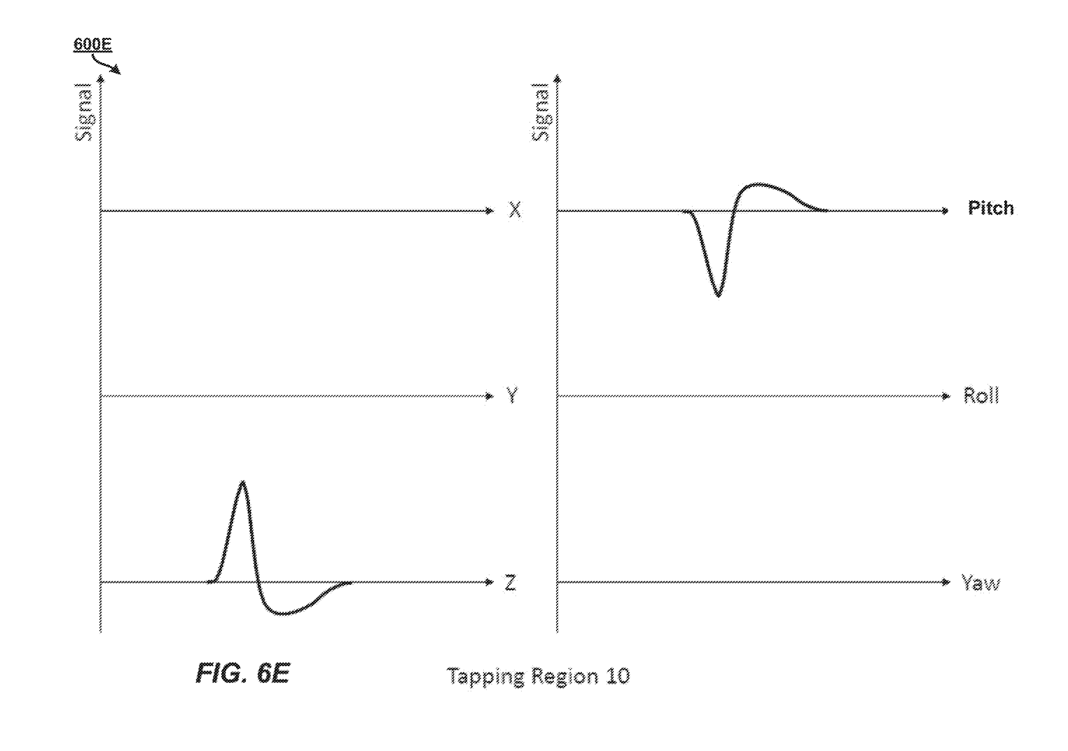

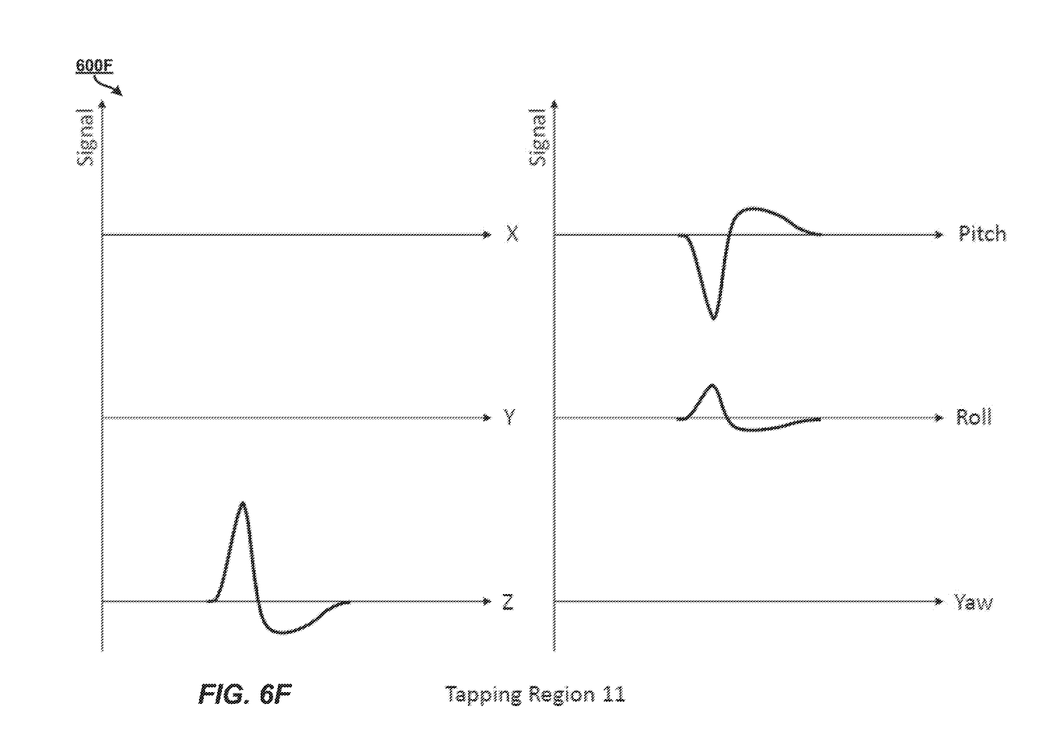

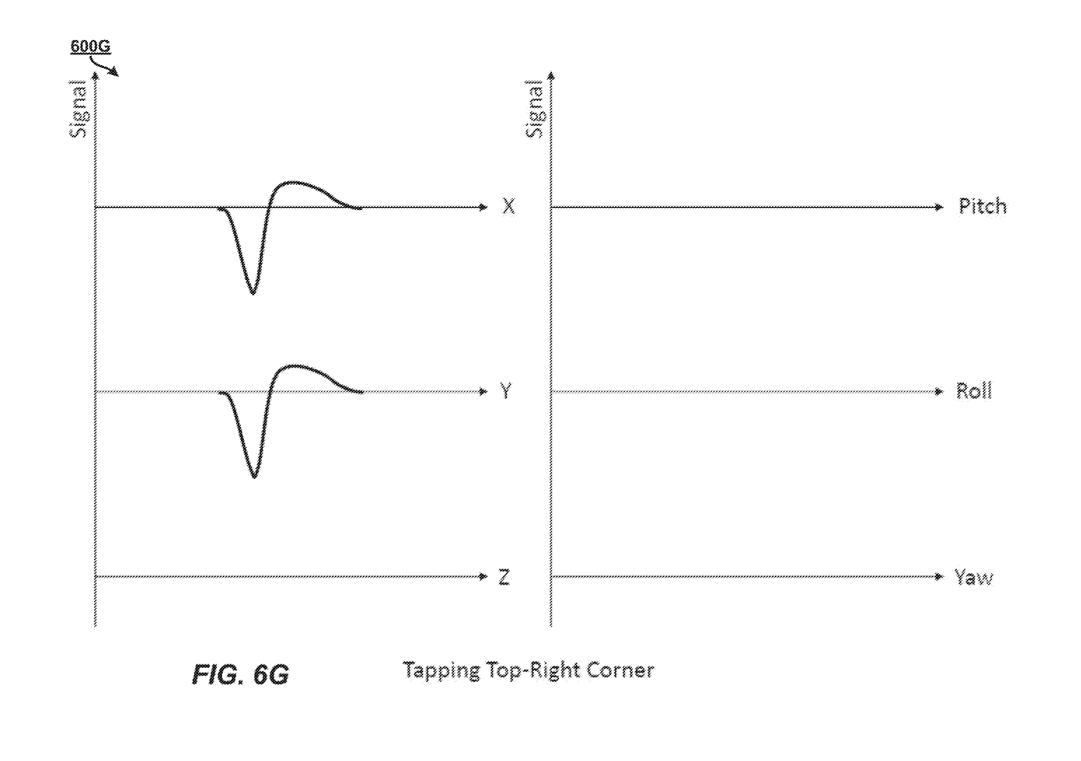

FIGS. 6A-6G illustrate signals generated by at least one of a plurality of accelerometers and/or a gyroscope representative of touch inputs received on regions of a computing device as illustrated in FIG. 4 according to examples of the present disclosure. In particular. FIG. 6A illustrates graphs 600A of a touch input against region 2, where the x-axis responds with a large signal, but all other axes are silent. Thus, this pattern defines the signature of a tap against region 2.

FIG. 6B illustrates graphs 600B of a touch input against region 1, where outputs from both x-axis and a positive yaw are simultaneously detected. With multiple touch inputs, it is important to consider the simultaneous nature of accelerometer responses, so that a touch input is accurately identified. Thus a heuristic may be defined as such: “Region 1 is tapped when there is a large positive signal from the x-axis and a large positive yaw.”

FIG. 6C illustrates graphs 600C of a touch input against region 3, which has a similar response to region 1 (FIG. 5b), but the yaw is negative. Thus the heuristic may be defined as such: “Region 3 is tapped when there is a large positive signal from the x-axis and a large negative yaw.”

Similarly, FIG. 6D illustrates a graphs 600D of a touch input against region 7, with a large z-axis response.

FIG. 6E illustrates graphs 600E of a touch input against region 10, which leads to a large positive z-response, but a small negative pitch. Similarly, a new heuristic may be developed for this condition.

FIG. 6F illustrates graphs 600F of a more complex touch input example where region 11 is tapped, leading to a large positive z-response, large negative pitch, and small positive roll.

FIG. 6G illustrates graphs 600G of a touch input against the top-right corner of the device, leading to large negative responses along the x-axis and the y-axis.

It should be appreciated that touch inputs against any region of the device may be inferred from unique and simultaneous responses from multiple accelerometers (small-large and positive/negative responses) and/or gyroscopes. Large/small and positive/negative are relative to the device. It should also be appreciated that each of these conditions, such as illustrated in the examples of FIGS. 5A-5G may lead to the definition of a heuristics, which may be used to identify how the mobile device is tapped.

It should be appreciated that an advantage of the present disclosure provides increased input modalities, which provide users with higher granularity of control over applications utilizing the present techniques (e.g., gaming application, text editing applications, graphic manipulating applications, etc.). For example, previous situations may provide only a few different touch input modalities. However, the present disclosure provides many different touch input modalities. For example, as shown in FIG. 5, 30 inputs are possible using single touch inputs, with that number increasing to 60 and 90 inputs with double and triple touches, respectively. In such cases, the user receives a richer interaction with the applications.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
receiving, by a computing system, a touch input on a touch input region of the computing system, the touch input region being one of a plurality of touch input regions;
generating, by the computing system, responsive to the received touch input, a linear touch input signal and a rotational touch input signal; and
determining, by the computing system, which of a discrete cursor movement from a set of discrete cursor movements to cause to be implemented based at least in part on an analysis of the linear signal generated by the accelerometer and based at least in part on an analysis of the rotational signal generated by the gyroscope.

2. The method of claim 1, wherein the linear touch input signal is generated by an accelerometer and is representative of a linear movement of the computing device caused by the touch input

3. The method of claim 2, wherein the linear touch input signal is at least one of an x-axis touch input signal representative of a movement of the computing device along an x-axis, a y-axis touch input signal representative of a movement of the computing device along a y-axis, and a z-axis touch input signal representative of a movement of the computing device along a z-axis.

4. The method of claim 1, wherein the rotational touch input signal is generated by a gyroscope and is representative of a rotational movement of the computing device caused by the touch input

5. The method of claim 4, wherein the rotational input signal is at least one of a pitch touch input signal representative of a movement of the computing device about an x-axis, a roll touch input signal representative of a movement of the computing device about a y-axis, and yaw touch input signal representative of a movement of the computing device about a z-axis.

6. A computing system comprising:
a plurality of accelerometers including:
a first accelerometer to generate an x-axis linear signal responsive to detecting a linear movement along an x-axis being caused by a touch input received on a touch input region of the computing system,
a second accelerometer to generate a y-axis linear signal responsive to detecting a linear movement along a y-axis being caused by the touch input on the computing system, and
a third accelerometer to generate a z-axis linear signal responsive to detecting a linear movement along a z-axis being caused by the touch input on the computing system;
a gyroscope to generate a rotational signal responsive to detecting a rotational movement caused by the touch input on the computing system;
a touch analysis module to analyze at least one of the linear signals generated by the plurality of accelerometers and to analyze the rotational signal generated by the gyroscope; and
a discrete cursor movement module to determine which of a discrete cursor movement from a set of discrete cursor movements to cause to be implemented based at least in part on the analysis of the linear signals generated by the plurality of accelerometers and based at least in part on the analysis of the rotational signal generated by the gyroscope.

7. The computing system of claim 6, wherein the touch analysis module analyzes the linear signals and the rotational signal by applying a signal de-noising algorithm to the signal generated by the accelerometer.

8. The computing system of claim 7, wherein the signal de-noising algorithm is a discrete wavelet transform algorithm.

9. The computing system of claim 6, wherein the rotational signal is at least one of a pitch touch signal representative of a movement of the computing device about an x-axis, a roll touch signal representative of a movement of the computing device about a y-axis, and yaw input signal representative of a movement of the computing device about a z-axis.

10. A computing system comprising:
a processing resource;
an accelerometer to generate a linear signal responsive to detecting a linear movement with respect to at least one of an x-axis, a y-axis, and a z-axis, the linear movement being caused by a touch input received on a region of the computing system;
a touch input analysis module to analyze the linear signal generated by the accelerometer by applying a signal de-noising algorithm to the linear signal generated by the accelerometer; and
a discrete cursor movement module to determine which of a discrete cursor movement from a set of discrete cursor movements to cause to be implemented based at least in part on the analysis of the linear signal generated by the accelerometer.

11. The computing system of claim 10, wherein the accelerometer comprises:
a first accelerometer to generate an x-axis linear signal responsive to detecting a linear movement along the x-axis;
a second accelerometer to generate a y-axis linear signal responsive to detecting a linear movement along the y-axis; and
a third accelerometer to generate a z-axis linear signal responsive to detecting a linear movement along the z-axis.

12. The computing system of claim 10, further comprising:
a gyroscope to generate a rotational signal responsive to detecting a rotational movement caused by the touch input on the computing system.

13. The computing system of claim 12, wherein the touch analysis module further analyzes the rotational signal generated by the gyroscope by applying the signal de-noising algorithm to the rotational signal generated by the gyroscope.

14. The computing system of claim 13, wherein the discrete cursor movement module determines which of the discrete cursor movement from the set of discrete cursor movements to cause to be implemented based at least in part on the analysis of the rotational signal generated by the gyroscope.

15. The computing system of claim 10, wherein the touch input region represents one of a plurality of touch input regions.
